(19) United States
(12) Patent Application Publication
(10) Pub. No.: US 2009/0218289 A1
(43) Pub. Date: Sep. 3, 2009

(54) RADIONUCLIDE RESINS

(75) Inventors: Burkhard Brings, Köln (DE); Reinhold Klipper, Köln (DE); Wolfgang Wambach, Köln (DE); Wolfgang Podszun, München (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/281,162

(22) PCT Filed: Feb. 27, 2007
(86) PCT No.: PCT/EP07/01676

§ 371 Date: Feb. 27, 2009

(30) Foreign Application Priority Data
Mar. 9, 2006 (DE) 102006011316.0

(51) Int. Cl. C02F 1/42

(52) U.S. Cl. 210/682

(57) ABSTRACT

The present application relates to a process for the adsorption of radionuclides from waters or aqueous solutions such as arise in nuclear plants, by contacting the water to be treated or the aqueous solutions with monodisperse, macroporous ion exchangers.

The present application relates to a process for the adsorption of radionuclides from waters or aqueous solutions such as arise, for example, in nuclear plants, preferably nuclear power stations, by contacting the water to be treated or the aqueous solutions with monodisperse, macroporous ion exchangers.

The use of ion exchangers for treating water in nuclear reactors has been described several times. U.S. Re. 34 112 describes the reduction of colloidally dissolved iron in the condensate water of a nuclear reactor by contacting said condensate water with a mixed-bed ion exchange resin, in which the cation resin has what is termed a core/shell morphology and the anion resin is produced from gel-type polymer beads having core/shell structure.

U.S. Pat. No. 5,449,462 discloses a process for the use of microporous or macroporous ion exchangers based on phosphonic acid which are produced from a sulfonated copolymer of acrylonitrile, styrene and/or divinylbenzene functionalized with diphosphonic acid groups, which is used for the sorption of radioisotopes, in particular actinide metal ions in oxidation states III, IV and VI, and also of transition metals and post-transition metals, from highly acidic and highly basic waste solutions. The copolymer beads have diameters between 100μ and 300μ and, in addition to customary heavy metals, are used for adsorbing the actinides Th, U, Pu and Am. Use is made of, for example, the resins Bio-Rad® AG MP 50, Diphonix®, Chelite®N or Chelite®P.

U.S. Pat. No. 5,308,876 discloses an ion exchanger having a regenerable cation exchange resin (the H form) and a regenerable anion exchange resin (the OH form), which are particulate organic polymeric adsorbents for adsorbing and removing suspended impurities which are present in trace amounts in the water to be treated and principally comprise metal oxides, wherein
the two resins comprise particles of exactly spherical shape having a diameter of 0.2-1.2 mm,
the cation exchange resin has an effective specific surface area of 0.02-0.20 m² per gram of dry resin and the anion exchange resin has an effective specific surface area of 0.02-0.10 m² per gram of dry resin, and the effective specific surface area is measured on the basis of the amount of adsorbed krypton and/or a gas equivalent to krypton,
the surface layer of the cation exchange resin has a structure in which grain particles bound to one another of a size of 0.1-1.0 μm are visible when they are viewed under a scanning electron microscope in the viewing field of which the enlargement is in a range from 50 to 200 000, preferably from 1000 to 10 000,
the cation exchange resin has a honeycomb-like or scale-like surface structure having grooves in the surface, the individual honeycombs or scales each have a surface area of 1-50 μm² and are agglomerated to one another to form an irregular surface structure and morphological arrangement, the surface is such that the individual honeycombs and/or scales adjoin one another via grooves having a width of 0.1-5.0 μm and a depth of 0.1-5.0 μm, and the grooves have a total length of 100-1000 mm/mm²,
the cation exchange resin has a double structure in which a skin layer up to a depth of at least 0.1-10 μm from the surface is present,
the cation exchange resin has a surface pH (concentration of hydrogen ions in the solid surface) of 1.50-1.90 in the wet state, and the ion exchange resin has a surface pH of 11.50-13.80 in the wet state, and
the cation exchange resin has an electrokinetic potential at the boundary surface (zeta potential) of −20 to −40 mV in a pulverulent state obtained by pulverization, and the anion exchange resin has an electrokinetic potential at the boundary surface of +20 to +45 mV in a pulverulent state obtained by pulverization.

U.S. Pat. No. 5,308,876 emphasizes the use as mixed bed for removing the crud iron such as can occur in nuclear reactors.

U.S. Pat. No. 5,518,627 discloses a process for removing anionic substances or radioactive substances using a strongly basic anion exchanger which comprises a crosslinked polymer having a building block unit of the formula

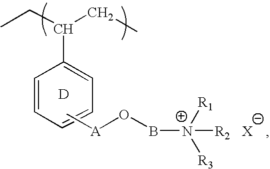

where A is a linear C₁₋₂ alkylene group, B is a linear C₄₋₈ alkylene group, each of R₁, R₂ and R₃ which can be identical or different is a C₁₋₄ alkyl group or a C₂₋₄ alkanol group, X is a counterion coordinated to the ammonium group, and the benzene ring D can have an alkyl group or a halogen atom as substituent.

DE 19 951 642 A1 (=US 2003 000 849) discloses a process for reducing cationic impurities in a cooling water circuit of a light water reactor, which cooling water circuit comprises a solution of cations, wherein cooling water of the cooling water circuit is passed through a first side of an electrodialysis unit and through a second side of the electrodialysis unit a medium of a concentrate circuit is passed in which an increased cation concentration is generated, and wherein, in a cesium-selective ion exchanger in the concentrate cycle the cationic impurities are filtered out of the medium.

U.S. Pat. No. 5,896,433 discloses a process for preventing the deposition of radioactive corrosion products in nuclear power plants of the boiling water reactor type which comprise a reactor having a reactor core in which deposits occur on surfaces outside the reactor core in direct or indirect contact with the reactor water, which comprises the following steps:
preparing a solution comprising ions of at least one metal by dissolving at least one soluble compound of this metal,
decomposing the counterion or the counterions of the compound in the solution to form gaseous products,
adding the solution, which may be transformed into a mixture or a slurry, to a circuit for reactor water or feed water.

In order to obtain the counterions, an ion-exchange column can be used in this case.

Finally, at the EPRI Low Level Redwaste Conference in June 2005, Terry Heller presented the action of macroporous ion-exchange resins on the purification of radionuclides. The high-performance cation resins presented in this case and also high-porosity anion resins and mixed beds are, or comprise, only heterodisperse ion exchangers.

However, it is extremely desirable to keep the radiation dose to which the personnel in a nuclear power plant is exposed as low as possible. A large part of this radiation dose is absorbed when overhaul, maintenance and repair processes are performed, when the nuclear power plant is shut down, during which the personnel is exposed, inter alia, to radiation during work on pumps, lines and the like of a reactor water circuit outside the reactor core. The reason for this is that radioactive corrosion products are deposited on the surfaces of system components outside the actual core. ⁶⁰Co is responsible for the majority in absolute terms of the radioactive radiation which originates from these corrosion products. ⁶⁰Co, in addition, has a half life of 5.3 years, which means it is virtually impossible to decrease the level of the radioactive radiation by allowing the personnel to carry out the work only after the reactor has been shut down for a certain time period.

In the reactor water circuit and a feed water circuit, the water causes separation of small amounts of material of various components with which it comes into contact. A large part of these components comprises stainless steel from which iron, nickel and small amounts of cobalt dissolve in the form of ions and particles. In relatively old plants, components are present in the reactor water circuit and feed water circuit, such as, for example, valves which comprise cobalt, which increases the amount of deposited cobalt. The metals which have passed in this manner into the reactor water and the feed water are deposited as oxides, termed “crud”, on surfaces in the circuit. The crud coating on the surfaces comprises various types of metal oxides and these, as they for example are situated on cladding tubes for nuclear fuel, are exposed to strong neutron radiation. In this process the metal atoms in the crud coating are transformed into nuclides, of which a part is radioactive. Particles fall off and ions separate from the radioactive crud coating and pass in this manner into the water. In this case the particles and ions are transported together with the reactor water to parts which are outside the core, in which case they carry radioactive material to these parts. The radioactive particles and the ions are then deposited as secondarily deposited crud coating on surfaces outside the core. Consequently a radioactive crud coating is also formed outside the core and it is this crud coating which leads to the personnel being exposed to radioactive radiation during servicing and repair work.

The object of the present invention was to remove the radionuclides produced by nuclear fission itself as rapidly and effectively as possible from the primary cooling water circuit of a nuclear power station in order to prevent or at least markedly reduce the formation of secondary nuclides or their accompanying components as are described in the above discussed prior art, for example the crud or various colloids, from the outset.

The solution of this object and therefore subject matter of the present invention is a process for the adsorption of radionuclides from waters or aqueous solutions of nuclear plants, preferably nuclear power stations, nuclear enrichment plants, nuclear reprocessing plants or else medical facilities, by contacting the water to be treated or the aqueous solutions with monodisperse macroporous ion exchangers.

Surprisingly, precisely monodisperse macroporous ion exchangers make possible the adsorption of radionuclides such as occur in nuclear fission so effectively that the servicing intervals in nuclear power plants can be prolonged. It has been found that monodisperse macroporous ion exchangers are exhausted significantly less rapidly by secondary effects such as crud deposition or deposition of colloids, as a result of which the efficacy of these ion exchangers is ensured over significantly longer times, which in turn beneficially effects the servicing intervals in nuclear plants, in particular in nuclear power stations.

The monodisperse macroporous ion exchangers to be used according to the invention can be used for this purpose in all sectors where radionuclides occur.

Preferably, they can be used in the breakdown of radioactive raw materials, for example for purification of mining effluence of bismuth or uranium extraction, for purifying waters in nuclear power stations, reprocessing plants, nuclear enrichment plants, or medical facilities, particularly preferably for purifying waters in fuel cooling ponds or waters or “heavy waters” in primary circuits of nuclear power stations, or in their cleaning circuits.

According to the invention, preferably monodisperse macroporous ion exchangers which are to be used are strongly basic anion exchangers, medium-basic anion exchangers, weakly basic anion exchangers, strongly acidic cation exchangers, weakly acidic cation exchangers, or what are termed chelate resins.

The production of monodisperse, macroporous ion exchangers is known in principle to those skilled in the art. A distinction is made between the fractionation of heterodisperse ion exchangers by sieving in essentially two direct production processes, that is to say jetting, and the seed-feed process in the production of the precursors, the monodisperse polymer beads. In the case of the seed-feed process, a monodisperse feed is used which itself can be generated, for example, by sieving or by jetting. Jetting processes are preferred.

In the present application, such polymer beads or ion exchangers are termed monodisperse for which the uniformity coefficient of the distribution curve is less than or equal to 1.2. The quotient of the factors d60 and d10 is termed uniformity coefficient. D60 describes the diameter at which 60% by mass in the distribution curve are smaller and 40% by mass are greater than or equal to. D10 denotes the diameter at which 10% by mass in the distribution curve are smaller and 90% by mass are greater than or equal to.

The particle size of the monodisperse macroporous ion exchangers is generally 250 to 1250 μm. It has now been found that the crud is removed particularly efficiently when use is made of monodisperse macroporous ion exchangers having particle sizes of 300 to 650 μm, preferably 350 to 550 μm.

The monodisperse polymer beads, the precursor of the ion exchanger, can be produced, for example, by reacting monodisperse, if appropriate encapsulated, monomer droplets comprising a monovinylaromatic compound, a polyvinylaromatic compound and also an initiator or initiator mixture, and if appropriate a porogen, in aqueous suspension. In order to obtain macroporous polymer beads for producing macroporous ion exchangers, the presence of porogen is absolutely necessary. In a preferred embodiment of the present invention, for synthesis of the monodisperse macroporous polymer beads, use is made of microencapsulated monomer droplets. The various processes for producing monodisperse polymer beads not only by the jetting principle but also by the seed-feed principle are known to those skilled in the art from the prior art. At this point, reference is made to U.S. Pat. No. 4,444,961, EP-A 0 046 535, U.S. Pat. No. 4,419,245 and WO 93/12167.

The macroporous property is given to the ion exchangers as soon as in the synthesis of their precursors, the polymer beads. The addition of what is termed porogen is therefore absolutely necessary. The composition of ion exchangers and their macroporous structure is described in DBP 1045102, 1957; DBP 1113570, 1957. As porogen for production of the polymer beads according to the invention, especially organic substances are suitable which dissolve in the monomer but dissolve or swell the polymer poorly. Examples which may be mentioned are aliphatic hydrocarbons such as octane, isooctane, decane, isododecane. In addition, those which are highly suitable are alcohols having 4 to 10 carbon atoms, such as butanol, hexanol and octanol.

The monodisperse ion exchangers to be used according to the invention have a macroporous structure. The expression “macroporous” is known to those skilled in the art. Details are described, for example, in J. R. Millar et al J. Chem. Soc. 1963, 218. The macroporous ion exchangers have a pore volume determined by mercury porosimetry of 0.1 to 2.2 ml/g, preferably 0.4 to 1.8 ml/g.

Functionalizing the polymer beads which are obtainable according to the prior art to give monodisperse, macroporous chelate resins is likewise substantially known to those skilled in the art from the prior art. For instance, EP-A 1078690 describes, for example, a process for production of monodisperse ion exchangers having chelating functional groups by the phthalimide process, by
a) reacting monomer droplets of at least one monovinylaromatic compound and at least one polyvinylaromatic compound and also a porogen, and/or if appropriate an initiator or an initiator combination, to give monodisperse crosslinked polymer beads,
b) amidomethylating these monodisperse crosslinked polymer beads with phthalimide derivatives,
c) reacting the amidomethylated polymer beads to give aminomethylated polymer beads and
d) reacting the aminomethylated polymer beads with chelating groups to give ion exchangers.

The monodisperse, macroporous chelate exchangers produced according to EP-A 1078690 carry the chelating groups forming during process step d)

—(CH₂)—NR₁R₂

where

R₁ is hydrogen or a radical CH₂—COOH or CH₂ P(O)(OH)₂

R₂ is a radical CH₂OOH or CH₂P(O)(OH)₂ and

n is an integer between 1 and 4.

In the further course of this application, such chelate resins are designated resins having iminodiacetic acid groups or having aminomethylphosphonic acid groups.

Production of monodisperse, macroporous chelate resins by the chloromethylation process is described in U.S. Pat. No. 4,444,961. Therein, haloalkylated polymers are aminated and the aminated polymer is reacted with chloroacetic acid to give chelate resins of the iminodiacetic acid type. Likewise monodisperse, macroporous chelate resins having iminodiacetic acid groups are obtained. Chelate resins having iminodiacetic acid groups can also be obtained by reaction of chloromethylated polymers with iminodiacetic acid.

In addition, thiourea groups can be present in the chelate exchanger. The synthesis of monodisperse, macroporous chelate exchangers having thiourea groups is known to those skilled in the art from U.S. Pat. No. 6,329,435, in which aminomethylated monodisperse polymer beads are reacted with thiourea. Monodisperse chelate exchangers having thiourea groups can also be obtained by reacting chloromethylated monodisperse polymers with thiourea.

Monodisperse, macroporous chelate exchangers having SH groups (mercapto groups), in the context of the present invention, are likewise suitable for the adsorption of radionuclides. These resins may be synthesized in a simple manner by hydrolysis of the last-mentioned chelate exchangers having thiourea groups.

However, monodisperse, macroporous chelate exchangers having additional acid groups can also be used according to the invention for the adsorption of radionuclides. WO 2005/049190 describes the synthesis of monodisperse chelate resins which comprise not only carboxyl groups but also —(CH₂)ₘNR₁R₂ groups, by reacting monomer droplets of a mixture of a monovinylaromatic compound, a polyvinylaromatic compound, a (meth)acrylic compound, an initiator or an initiator combination, and also if appropriate a porogen, to give crosslinked polymer beads, functionalizing the resultant polymer beads with chelating groups, and in this step reacting the copolymerized (meth)acrylic compounds to give (meth)acrylic acid groups, wherein
m is an integer from 1 to 4,
R₁ is hydrogen or a CH₂—COOR₃ radical or CH₂P(O)(OR₃)₂ or —CH₂—S—CH₂COOR₃ or —CH₂—S—C₁-C₄ alkyl or
—CH₂—S—CH₂CH(NH₂)COOR₃ or

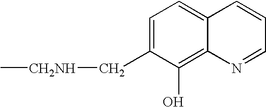

or its derivatives or C═S(NH₂),
R₂ is a CH₂COOR₃ radical or CH₂P(O)(OR₃)₂ or —CH₂—S—CH₂COOR₃ or —CH₂—S—C₁C₄ alkyl or —CH₂—S—CH₂CH(NH₂)COOR₃ or

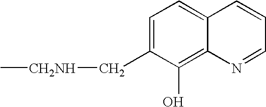

or its derivatives or C═S(NH₂) and
R₃ is H or Na or K.

Monodisperse, macroporous chelate resins having picolinamino groups which are known from DE-A 10 2006 00 49 535 can also be used for the adsorption of radionuclides. These are obtainable by
a) producing monodisperse, macroporous polymer beads based on styrene, divinylbenzene and ethylstyrene according to the above-described prior art either by jetting or by a seed-feed process,
b) amidomethylating these monodisperse macroporous polymer beads,
c) converting the function of the amidomethylated polymer beads in the alkaline medium to aminomethylated polymer beads and
d) functionalization with picolyl chloride hydrochloride to give the desired monodisperse chelate exchanger having picolinamino groups.

The production of monodisperse, macroporous, strongly basic anion exchangers is known to those skilled in the art. These anion exchangers can be produced by amidomethylation of crosslinked monodisperse macroporous styrene polymers and subsequent quaternization of the resultant aminomethylate. A further synthesis pathway for monodisperse, macroporous, strongly basic anion exchangers is chloromethylation of said polymer beads with subsequent animation, for example using trimethylamine or dimethylaminoethanol. Monodisperse, macroporous, strongly basic anion exchangers which are preferred according to the invention can be obtained by the process described in EP 1 078 688.

Monodisperse, macroporous, weakly basic anion exchangers may be obtained by alkylating the above-described aminomethylate. By partial alkylation, the monodisperse, macroporous, weakly basic anion exchangers can be converted into monodisperse, macroporous, medium-basic anion exchangers. The production of these anion exchanger types is likewise described in EP 1 078 688.

Monodisperse, macroporous, weakly basic or strongly basic anion exchangers of the acrylate type are likewise suitable. Their production can proceed, for example, according to EP 1 323 473.

Macroporous, monodisperse, weakly acidic cation exchangers which are suitable for the process according to the invention are described in P001 00082.

The monodisperse polymer beads can also be converted to anion or cation exchange beads using processes known in the specialist field for conversion of crosslinked addition polymers of mono- and polyethylenically unsaturated monomers. In the production of weakly basic resins from poly(vinylaromatic) copolymer beads, such as crosslinked polystyrene beads, the beads are advantageously haloalkylated, preferably halomethylated, optimally chloromethylated, and the ion-active exchange groups are subsequently added to the haloalkylated copolymer. The processes for haloalkylation of crosslinked addition copolymers and the haloalkylating agents which participated in these processes are known in the art to which reference is made for the purposes of this invention: U.S. Pat. No. 4,444,961 and “ion exchange” by F. Helfferich, published 1962 by the McGraw-Hill Book Company, N.Y. Usually, the haloalkylation reaction comprises swelling the crosslinked addition copolymer with a haloalkylating agent, preferably bromomethyl methyl ether, chloromethyl methyl ether or a mixture of formaldehyde and hydrochloric acid, optimally chloromethyl methyl ether, and the subsequent reaction of the copolymer and the haloalkylating agent in the presence of a Friedel-Craft catalyst, such as zinc chloride, iron chloride and aluminum chloride.

Generally, the monodisperse, macroporous ion exchangers of haloalkylated beads are produced by contacting these beads with a compound which reacts with the halogen of the haloalkyl group and which in the reaction forms an active ion exchange group. Such methods and compounds to obtain therefrom ion exchange resins, i.e. weakly basic resins and strongly basic monodisperse, macroporous anion exchangers, are known in the art: U.S. Pat. No. 4,444,961. Usually, a weakly basic monodisperse, macroporous anion exchange resin is produced by contacting the haloalkylated copolymer with ammonia, a primary amine or a secondary amine. Representative primary or secondary amines include methylamine, ethylamine, butylamine, cyclohexylamine, dimethylamine, diethylamine and the like. Strongly basic monodisperse, macroporous ion exchange resins are produced by using tertiary amines, such as trimethylamine, triethylamine, tributylamine, dimethylisopropanolamine, ethylmethylpropylamine or the like as aminating agents.

Amination generally includes heating a mixture of the haloalkylated copolymer beads and at least a stoichiometric amount of the aminating agent, i.e. ammonia or amine, under reflux to a temperature which is sufficient to react the aminating agent with the halogen atom which is located on the carbon atom in the alpha position to the aromatic nucleus of the polymer. It is advantageous when, if appropriate, a swelling agent such as water, ethanol, methanol, methylene chloride, ethylene dichloride, dimethoxymethylene or combinations thereof is used. Usually, the amination is carried out under conditions such that the anion exchange sites are uniformly distributed in the entire bead. A substantially complete amination is generally obtained within about 2 to about 24 hours at a reaction temperature between 25 and about 150° C.

Further methods for adding other types of anion exchange groups, such as phosphonium groups, to copolymer beads are described in U.S. Pat. No. 5,449,462.

Monodisperse, macroporous cation exchange resin beads can be produced by processes known in the art for conversion of the crosslinked addition copolymer of mono- and polyethylenically unsaturated monomers. An example of such processes for producing a monodisperse, macroporous cation exchange resin is U.S. Pat. No. 4,444,961. Generally, the ion exchange resins which are usable according to the invention are strongly acidic monodisperse, macroporous resins which are produced by sulfonating the copolymer beads. Whereas the sulfonation can generally be carried out in the pure state, the beads are swollen using a suitable swelling agent, and the swollen beads are reacted with the sulfonating agent, such as sulfuric acid or chlorosulfonic acid or sulfur trioxide. Preferably, use is made of an excess of sulfonating agent, of, for example, about 2 times to about 7 times the weight of the copolymer beads. The sulfonation is carried out at a temperature of about 0° C. to about 150° C.

Since the amount of crosslinker, for example divinylbenzene, which is used in the production of the beads having a core and sheath structure changes as a function of the structure radius owing to the processes used for producing these, a process for expressing the degree of crosslinking which reflects this fact is used. In the case of the non-functionalized copolymer beads, a toluene swelling test can be used for determining the “effective” crosslinking density, as is stated, for example, in example 1 of USRE 34,112.

With respect to carrying out the process according to the invention, i.e. the use of monodisperse, macroporous ion exchangers in daily work sequences, for example in a boiling water reactor, no significant changes are necessary apart from the fact that the ton exchangers which are currently used for removing ions are replaced by one of the mixed-bed ion exchangers described in the present application.

When “breakthrough” occurs, the mixed-bed exchanger can usually be reactivated a plurality of times by stirring the bed. Owing to the sensitive site of use, the ion exchange bed is usually not regenerated in the same sense as standard ion exchangers, i.e. by the use of strong acids and bases. Instead, the exhausted resin having the trapped radionuclides and any additional radioactive substances is usually solidified, collected and disposed of in the same manner as other low-level radioactive waste from nuclear power station reactors.

Waste waters from the bed can be monitored using standard appliances, such as measuring instruments for weak scintillation and radionuclide-specific analytical processes, in order to observe when a breakthrough occurs, so that at this time point the necessary steps can be taken for reactivating the bed or collecting and disposing of the used resin.

Because the monodisperse, macroporous resins are extraordinarily tough and fracture resistant, the generation of “fines fractions” is kept to a minimum extent, which further improves performance and service life of the resin bed. Standard processes for sieving the resins in order to remove all fines fractions produced during transport and handling of the resins can of course be used on charging the plant for the first time in order to maximize the performance of the mixed-bed ion exchanger.

According to the process of the invention, it is possible to adsorb radionuclides, particularly as arise in nuclear plants, effectively from waters or aqueous solutions.

Radionuclides is a collective term for all nuclides which differ from stable nuclides by radioactivity and which convert into stable nuclides by possibly a plurality of radioactive transformations. They can be of natural origin (for example ⁴⁰K or the members of the 3 large decay series) or can be produced artificially by nuclear reactions (for example transuranics).

Important natural radionuclides are, for example, ²¹⁰Po, ²²⁰Rn, ²²⁶Ra, ²³⁵U, ²³⁸U. They decay with α- or β-emission; as an accompanying phenomenon, frequently (for example in the case of ²³⁶Ra), γ quanta are emitted, the energy of which is likewise a plurality of MeV or keV. The artificially generated radionuclides, as arise, for example, in nuclear plants, are of considerably more importance for use of the monodisperse macroporous ion exchangers. Radionuclides which are not very short-lived occur in the nuclear fission of uranium in reactors, when used fuel elements are processed, for example by the Purex process. The most important fission products include ⁸⁵Kr, ¹³⁷Cs, ⁸⁹Sr, ⁹⁰Sr, ¹⁴⁰Ba, ⁹⁵Zr, ⁹⁰Mo, ¹⁰⁶Ru, ¹⁴⁴Ce, ¹⁴⁷Nd, which themselves are in turn mother nuclides of further daughter products resulting mostly by beta decay.

As a result of the nuclear reaction, further radionuclides (from ambient nuclides) are formed in the nuclear reactor, such as ³¹P, ³²P, ⁵⁹Co, ⁶⁰Co, ¹⁹⁷Au or ¹⁹⁸Au.

All said radionuclides may be isolated from waters or aqueous solutions by the process according to the invention by means of the monodisperse macroporous ion exchangers.

In addition, however, short-lived radionuclides such as are used in particular in medicine can also be absorbed, preferably ¹³¹In, ^{99m}Tc, ⁶⁴Cu, ¹⁹⁷Hg, ¹⁹⁸Au, ¹³¹I to ¹⁴²I, ⁵⁹Fe.

The present invention therefore also relates to the use of monodisperse, macroporous ion exchangers for the adsorption of radionuclides from waters or aqueous solutions, preferably of ²¹⁰Po, ²²⁰Ru, ²²⁶Ra, ²³²Th, ²³⁵U, ²³⁸U, ⁸⁵Kr, ¹³⁷Cs, ⁸⁹Sr, ⁹⁰Sr, ¹⁴⁰Ba, ⁹⁵Zr, ⁹⁹Mo, ¹⁰⁶Ru, ¹⁴⁴Ce, ¹⁴⁷Nd, ³¹P, ³²P, ⁵⁹Co, ⁶⁰Co, ¹⁹⁷Au, ¹⁹⁸Au, ¹³¹In, ⁹⁹Tc, ⁶⁴Cu, ¹⁹⁷Hg, ¹³¹I to ¹⁴²I, ⁵⁹Fe, ⁴⁰K, ²⁴Na.

The greater the diameter of the monodisperse ion exchangers is, the smaller is the number of monodisperse beads in total per m³ of ion exchanger. The smaller the beads are, the more beads are present in one m³ of ion exchanger. Linked thereto is the fact that the total surface area of all beads which are present in one m³ of ion exchanger increases with decreasing bead diameter.

For the adsorption of radionuclides from liquids it is necessary that the total surface area of all beads via which the adsorption proceeds is as large as possible. This is best ensured with monodisperse, macroporous ion exchangers of small bead diameter, since owing to the monodispersity, the diffusion pathways of the radionuclides into the beads are equally long, in addition, the total surface area is increased by beads of small diameter, and the adsorption is promoted by the macroporosity.

### Methods of Analysis:

Number of Perfect Beads after Production

100 beads are viewed under the microscope. The number of beads which carry cracks or show fragmentation is determined. The number of perfect beads results from the difference between the number of damaged beads and 100.

### Usable Capacity of Strongly Basic Anion Exchangers

1000 ml of anion exchanger in the chloride form, i.e. the nitrogen atom bears chloride as counterion, are charged into a glass column. 2500 ml of 4% strength by weight sodium hydroxide solution are filtered through the resin in 1 hour. The column is then washed with 2 liters of debased, i.e. decationized, water. Then, water having a total anion hardness of 25 degrees of German hardness are filtered through the resin at a rate of 10 liters per hour. In the eluate, the hardness and also the residual amount of silicic acid are analyzed. At a residual silicic acid content of ≧0.1 mg/l, loading is ended.

From the amount of water which is filtered through the resin, the total anion hardness of the water filtered through and also the amount of resin installed, the number of grams of CaO which are absorbed per liter of resin is determined. The gram amount of CaO is the usable capacity of the resin in the unit of gram of CaO per liter of anion exchanger.

### Determination of the Amount of Basic Aminomethyl Groups in the Aminomethylated, Crosslinked Polystyrene Polymer Beads

100 ml of the aminomethylated polymer beads are vibrated on the tamping volumeter and subsequently flushed by demineralized water into a glass column. In 1 hour and 40 minutes, 1000 ml of 2% strength by weight sodium hydroxide solution are filtered through. Subsequently, demineralized water is filtered until 100 ml of eluate admixed with phenolphthalein have a consumption of 0.1 n (0.1 normal) hydrochloric acid of at most 0.05 ml.

50 ml of this resin are admixed in a glass beaker with 50 ml of demineralized water and 100 ml 1 n hydrochloric acid. The suspension is stirred for 30 minutes and subsequently charged into a glass column. The liquid is drained off. A further 100 ml of In hydrochloric acid is filtered through the resin in 20 minutes. Subsequently, 200 ml of methanol are filtered through. All eluates are collected and combined and titrated with 1 n sodium hydroxide solution against methyl orange.

The amount of aminomethyl groups in 1 liter of aminomethylated resin is calculated using the following formula: (200−V)·20=mol of aminomethyl groups per liter of resin.

### Determination of the Amount of Weakly and Strongly Basic Groups in Anion Exchangers

100 ml of anion exchanger are charged with 1000 ml of 2% strength by weight sodium hydroxide solution in a column in 1 hour and 40 minutes. The resin is then washed with demineralized water for removing the excess sodium hydroxide solution.

### Determination of the NaCl Number

50 ml of the exchanger in the free base form and washed to neutrality are placed in a column and charged with 950 ml of 2.5% strength by weight sodium chloride solution. The effluent is collected, made up to 1 liter with demineralized water and 50 ml thereof are washed with 0.1 n (=0.1 normal hydrochloric acid) hydrochloric acid.

ml of 0.1 n hydrochloric acid consumed×4/100=NaCl number in mol/l of resin.

Determination of the NaNO3 number

Then, 950 ml of 2.5% strength by weight sodium nitrate solution are filtered through. The effluent is made up to 1000 ml with demineralized water. An aliquot thereof, 10 ml, is taken off and analyzed for its chloride content by titration with mercury nitrate solution.

ml of Hg(NO3) solution consumed×factor/17.75=NaNO3 number in mol/l of resin.

### Determination of the HCl Number

The resin is washed with demineralized water and flushed into a glass beaker. It is admixed with 100 ml of 1 n hydrochloric acid and allowed to stand for 30 minutes. The entire suspension is flushed into a glass column. A further 100 ml of hydrochloric acid are filtered through the resin. The resin is washed with methanol. The effluent is made up to 1000 ml with demineralized water. Approximately 50 ml thereof are titrated with 1 n of sodium hydroxide solution.

(20 ml of 1 n sodium hydroxide solution consumed)/5=HCl number in mol/l of resin.

The amount of strongly basic groups is equal to the sum of NaNO3 number and HCl number.

The amount of weakly basic groups is equal to the HCl number.

### Uniformity Coefficient

Quotient of the bead sizes at which 60 and 10 percent by mass fall through a sieve.

### Median Bead Diameter

Bead diameter at which 50% of the beads are greater and smaller.

Determination of the Amount of Chelating Groups—Total Capacity (TC) of the Resin

100 ml of exchanger are charged into a filter column and eluted with 3% strength by weight hydrochloric acid in 1.5 hours. The column is then washed with demineralized water until the effluent is neutral.

50 ml of regenerated ion exchanger are charged in a column with 0.1 n sodium hydroxide solution (=0.1 normal sodium hydroxide solution). The effluent is collected each time in a 250 ml measuring flask and the total amount is titrated with 1 n hydrochloric acid against methyl orange.

Application is continued until 250 ml of effluent have a consumption of 24.5-25 ml of 1 n hydrochloric acid. After the test is ended the volume of exchanger in the Na form is determined.

Total capacity (TC)=(X·25−ΣV)·2·10⁻² in mol/l of exchanger.

X=number of effluent fractions

ΣV=total consumption in ml of 1 n hydrochloric acid in the titration of the effluents.

### EXAMPLES

### Example 1

Production of a Macroporous, Monodisperse Chelate Resin having Iminodiacetic Acid Groups

### 1a) Production of the Monodisperse, Macroporous Polymer Beads Based on Styrene, Divinylbenzene and Ethylstyrene

3000 g of demineralized water are charged into a 101 glass reactor and a solution of 10 g of gelatin, 16 g of disodium hydrogenphosphate dodecahydrate and 0.73 g of resorcinol in 320 g of deionized water are added and mixed. The mixture is heated to 25° C. With stirring, subsequently, a mixture of 3200 g of microencapsulated monomer droplets having a narrow particle size distribution of 3.6% by weight divinylbenzene and 0.9% by weight ethylstyrene (used as commercially available isomeric mixture of divinylbenzene and ethylstyrene having 80% divinylbenzene), 0.5% by weight dibenzoyl peroxide, 56.2% by weight styrene and 38.8% by weight isododecane (technical isomeric mixture having a high fraction of pentamethylheptane) is added, wherein the microcapsules consist of a formaldehyde-cured complex coacervate of gelatin and a copolymer of acrylamide and acrylic acid, and 3200 g of aqueous phase having a pH of 12 are added. The median particle size of the monomer droplets is 260 μm.

The batch is polymerized to completion with stirring by temperature elevation according to a temperature program starting at 25° C. and ending at 95° C. The batch is cooled, washed over a 32 μm sieve and subsequently dried in a vacuum at 80° C. This produces 1893 g of a spherical polymer having a median particle size of 250 μm, narrow particle size distribution and smooth surface.

The polymer is chalky white in appearance and has a bulk density of approximately 350 g/l.

### 1b) Production of the Amidomethylated Polymer Beads

At room temperature, 1596 g of dichloroethane, 470 g of phthalimide and 337 g of 29.1% strength by weight formalin are charged. The pH of the suspension is set to 5.5 to 6 using sodium hydroxide solution. The water is then removed by distillation. Then, 34.5 g of sulfuric acid are added. The resultant water is removed by distillation. The batch is cooled. At 30° C., 126 g of 65% strength oleum and subsequently 424 g monodisperse polymer beads produced in accordance with process step 1a) are added. The suspension is heated to 70° C. and stirred for a further 6 hours at this temperature. The reaction broth is taken off, demineralized water is added and residual amounts of dichloroethane are removed by distillation.

Yield of amidomethylated polymer beads: 1800 ml

Composition by Elemental Analysis:

| | | |
|---|---|---|
| Carbon: | 78.5% | by weight; |
| Hydrogen: | 5.2% | by weight; |
| Nitrogen: | 4.8% | by weight; |

| | |
|---|---|
| Remainder: | oxygen. |

### 1c) Production of the Aminomethylated Polymer Beads

478 g of 50% strength by weight sodium hydroxide solution and 1655 ml of demineralized water are added to 1785 ml of amidomethylated polymer beads at room temperature. The suspension is heated to 180° C. and stirred for 6 hours at this temperature.

The resultant polymer beads are washed with demineralized water.

Yield of aminomethylated polymer beads: 1530 ml

Composition by Elemental Analysis:

| | | |
|---|---|---|
| Carbon: | 82.9% | by weight |
| Nitrogen: | 8.0% | by weight |
| Hydrogen: | 8.2% | by weight |
| HCl number: | 1.81 | mol/l |

From the composition by elemental analysis of the aminomethylated polymer beads, it may be calculated that on a statistical average per aromatic nucleus, originating from the styrene and divinylbenzene units, 0.78 hydrogen atoms were substituted by aminomethyl groups.

### 1d) Production of the Ion Exchanger Having Chelating Iminodiacetic Acid Groups

1530 ml of aminomethylated polymer beads from example 1c) are added to 1611 ml of demineralized water at room temperature. The suspension is heated to 90° C. At this temperature, to this suspension there are added in 4 hours 589 g of sodium salt of monochloroacetic acid, wherein the pH is maintained at 9.2 using sodium hydroxide solution. Subsequently, the suspension is heated to 95° C. and stirred for a further 6 hours at this temperature. The pH is set to and maintained at 10.5.

Thereafter the suspension is cooled. The resin is washed with demineralized water.

### Yield: 2700 ml

Total capacity of the resin: 1.92 mol/l of resin
Median bead diameter of the resin: 345μ
Resin stability: 99% whole beads
Uniformity coefficient: 1.035

The total surface area of all beads which are present in one m³ of chelate resin is 6521739 m².

### Example 2

Production of a Macroporous, Monodisperse Strongly Acidic Cation Exchanger

In a reactor, 3245 grams of 98% strength by weight sulfuric acid are charged at room temperature. The sulfuric acid is heated to 105° C. At this temperature, 200 grams of monodisperse, macroporous polymer beads from example 1a are added in the course of one hour. The suspension is heated to 115° C. in the course of 30 minutes. It is stirred for a further 5 hours at 115° C.

After cooling to room temperature, the suspension is flushed into a glass column using 78% strength by weight sulfuric acid and sulfuric acids of decreasing concentration starting with 78% strength by weight sulfuric acid are filtered through. Subsequently the column is washed with demineralized water.

Then, 4% strength by weight aqueous sodium hydroxide solution is filtered through the resin. The resin is transformed by this from the hydrogen form to the sodium form.

Resin yield: 3250 ml
Total capacity in the hydrogen form: 1.01 mol/l of resin
Total capacity in the sodium form: 1.09 mol/l
Resin stability: 100% whole beads
Median bead diameter: 376μ
Uniformity coefficient: 1.033

The total surface area of all beads which are present in one m³ cation exchanger is 5984042 m².

### Example 3

### Production of a Strongly Basic Monodisperse, Macroporous Anion Exchanger

### 3a) Production of the Amidomethylated Polymer Beads

2440 g of dichloroethane, 659 g of phthalimide and 466 g of 29.4% strength by weight formalin are charged at room temperature. The pH of the suspension is set to 5.5 to 6 using sodium hydroxide solution. Subsequently the water is removed by distillation. Then, 48.3 g of sulfuric acid are added. The resultant water is removed via distillation. The batch is cooled. At 30° C., 165 g of 65% strength oleum and subsequently 424 g of monodisperse polymer beads produced by process step 1a) are added. The suspension is heated to 70° C. and stirred for a further 6 hours at this temperature. The reaction broth is taken off, demineralized water is added and residual amounts of dichloroethane are removed by distillation.

Yield of amidomethylated polymer beads: 2200 ml

### Composition by Elemental Analysis:

| | | |
|---|---|---|
| Carbon: | 76.6% | by weight; |
| Hydrogen: | 4.9% | by weight; |
| Nitrogen: | 5.4% | by weight; |

| | |
|---|---|
| Remainder: | oxygen. |

### 3b) Production of the Aminomethylated Polymer Beads

662 g of 50% strength by weight sodium hydroxide solution and 1313 ml of demineralized water at room temperature are added to 2170 ml of amidomethylated polymer beads. The suspension is heated to 180° C. in the course of 2 hours and stirred at this temperature for 6 hours.

The resultant polymer beads are washed with demineralized water.

Yield of aminomethylated polymer beads: 1760 ml

This gives a total yield, estimated, of 2288 ml.

### Composition by Elemental Analysis:

| | | |
|---|---|---|
| Nitrogen: | 9.6% | by weight |
| Carbon: | 78.9% | by weight; |
| Hydrogen: | 8.2% | by weight; |

We calculated from the composition by elemental analysis of the aminomethylated polymer beads that on a statistical average, per aromatic nucleus, originating from the styrene and divinylbenzene units, 1.04 hydrogen atoms were substituted by aminomethyl groups.

### Determination of the Amount of Basic Groups: 2.0 Mol/Liter of Resin

3c) Production of the Strongly Basic Anion Exchanger

468 ml of 50% strength by weight sodium hydroxide solution and 1720 ml of aminomethylated polymer beads from example 3b) are added to 2891 ml of demineralized water. Subsequently, 636 grams of chloromethane are added.

The batch is heated to 40° C. and stirred at this temperature for 16 hours. After cooling, the resin is first washed with water. The resin is transferred into a column and 3000 ml of 5% strength by weight aqueous sodium chloride solution are filtered through in the course of 30 minutes from the top.

Subsequently the resin is washed with water and classified.

Resin yield: 2930 ml
Median bead diameter: 380μ
Uniformity coefficient: 1.035
NaCl number: 0.593 mol/l of resin
NaNO3 number: 1.03 mol/l of resin
HCl number: 0.005 mol/l of resin
Resin stability: 99% whole beads
Usable capacity: 0.57 mol/l of resin

The total surface area of all beads which are present in one m³ of strongly basic anion exchanger is 5921052 m².

1. A process for the adsorption of at least one radionuclide from water or aqueous solution, comprising:
contacting the water or the aqueous solution with a monodisperse, macroporous ion exchanger.

2. The process as claimed in claim 1, wherein the water or aqueous solution is from a nuclear plant, nuclear power station, reprocessing plant, nuclear enrichment plant, or medical facility.

3. The process according to claim 1, wherein the monodisperse macroporous ion exchanger is a chelate resin, an anion exchanger, or a cation exchanger.

4. The process according to claim 1, wherein the monodisperse macroporous ion exchanger comprises particles having a particle size of 250 to 1250 μm.

5. The process according to claim 4, wherein the anion exchanger is a strongly basic anion exchanger.

6. The process according to claim 4, wherein the cation exchanger is a strongly acidic cation exchanger.

7. The process according to claim 1, wherein the radionuclide is one or more of ²¹⁰Po, ²²⁰Ru, ²²⁶Ra, ²³²Th, ²³⁵U, ²³⁸U, ⁸⁵Kr, ¹³⁷Cs, ⁸⁹Sr, ⁹⁰Sr, ¹⁴⁰Ba, ⁹⁵Zr, ⁹⁹Mo, ¹⁰⁶Ru, ¹⁴⁴Ce, ¹⁴⁷Nd, ³¹P, ³²P, ⁵⁹Co, ⁸⁰Co, ¹⁹⁷Au, ¹⁹⁸Au, ¹³¹In, ⁹⁹Tc, ⁶⁴Cu, ¹⁹⁷Hg, ¹³¹I to ⁵⁹Fe, ⁴⁰K, and ²⁴Na.

8. The process according to claim 1, wherein the monodisperse macroporous ion exchanger has a pore volume of 0.1 to 2.2 ml/g.

9. The process as claimed in claim 8, wherein the monodisperse, macroporous ion exchanger if formed from the polymerization of at least one monomer and at least one crosslinker, and further wherein the porosity is achieved by adding 40 to 150 parts by weight of porogen, based on 100 parts by weight of the sum of the monomer and the crosslinker.

10. (canceled)

11. The process according to claim 1, wherein the monodisperse macroporous ion exchanger comprises particles having a particle size of 300 to 650 μm.

12. The process according to claim 1, wherein the monodisperse macroporous ion exchanger has a pore volume of 0.4 to 1.8 ml/g.
